(19) United States
(12) Patent Application Publication
(10) Pub. No.: US 2008/0090447 A1
(43) Pub. Date: Apr. 17, 2008

(54) Wire strain relief structure and method

(76) Inventor: Lars David Moravy, Powell, OH (US)

Correspondence Address: CERMAK KENEALY & VAIDYA, LLP, 515 EAST BRADDOCK RD SUITE B, Alexandria, VA, 22314, US

(21) Appl. No.: 11/549,456

(22) Filed: Oct. 13, 2006

(51) Int. Cl. H01R 13/58

(52) U.S. Cl. 439/449

(57) ABSTRACT

A wire strain relief cover and method can include a high flex wire connected to a vehicle component, such as a wheel mount structure or other vehicle suspension component, and can include a connector or connector cover that reduces the amount of vibration and stress transferred between the wire and vehicle component. The wire can be a polyurethane wire of the type typically used in high vibration vehicle environments, and can include at least one lead covered in a polyurethane sheath. The connector or connector cover can include a body portion that connects the wire and a strain relief portion that connects the cover to a sheathed portion of the wire to prevent vibration and stress transmission between the vehicle component and the wire.

### BACKGROUND

1. Field

The disclosed subject matter relates to a wire strain relief structure and method of use. More specifically, a wire strain relief connector or connector cover can be configured for use in high vibration environments to reduce vibration transmission between connected parts, and can be used in attachment configurations for particular components of a vehicle.

2. Brief Description of the Related Art

The wheel mount structure of a vehicle is subject to enormous accelerations during use. During use, high and low energy vibrations are continually applied to components of the wheel mount structure, including wires that are attached to many of the subcomponents of the wheel mount structure. Conventionally, high flex wire (e.g., polyurethane wire) is used to connect devices, such as monitoring and controlling systems, to a sensor or other subcomponent apparatus located on the vehicle suspension and wheel mount structure. Typically, the high flex wire is welded or otherwise permanently affixed (hardwired) to antilock brake system and other sensors at the vehicle suspension and wheel mount structure. The permanent fixation provides a great deal of flex for this high vibration connection, and prevents failure of the connection.

Recently, however, additional monitoring and/or controlling of a vehicle's suspension components is desired for input into suspension control, ABS control, safety and other monitoring and control devices. Particular examples of such devices include active springs (air springs), active dampers, active stabilizer bars, and improved antilock brake systems. If a wire is connected to such a structure, it makes economic sense to ensure that the wire is removable. Thus, if the sensor/controller or wire fails, only the sensor/controller or wire require replacing—avoiding the cost of replacing the entire stabilizer bar, damper, spring or suspension component. In the past, antilock brake system components could be replaced with the failed wire or monitor device without exorbitant cost to the consumer.

Thus, the invention relates to a connector for a polyurethane wire in the high vibration environment of the vehicle suspension, wheel mount structure and/or other high vibration structures in a vehicle.

The relevant art describes various ways for connecting a wire to another component. For example, U.S. Patent Application Publication No. 2004/0102082 to Tsuji et al. discloses a connector that includes a cover for protecting typical electrical wires that extend from a connector housing. The cover can include opposed halves that mount on the housing and thus protects electrical wires that extend from the housing.

U.S. Pat. No. 6,478,609 discloses a strain relief assembly that can be mounted between an electrical cable connector and its associated cable for a typical wiring system.

The relevant art does not specifically address certain known problems in the wire strain relief and connector art, including problems that exist in high vibration environments such as in wheel mount, suspension, and other vehicle component structures.

### SUMMARY

The disclosed subject matter relates to a product and method for securing high flex electrical wires in high vibration environments.

According to an aspect of the disclosed subject matter, a strain relief connector can be provided on a high flex electrical wire that is mounted at high vibration wheel mount areas in vehicles. Specifically, the strain relief device can be installed on a polyurethane wire that is currently used for connection to antilock brake system sensors (and other sensors) at the wheel mount structure. For example, the connector can be attached to a wire that includes a twisted pair of leads sheathed in a polyurethane cover.

In accordance with another aspect of the disclosed subject matter, a method of connecting a wire to a high vibration vehicle component can include: providing a vehicle suspension system including a wheel mount structure, a sensing/controlling device attached to the suspension system, and a high flex wire including a connector having a strain relief portion. The sensing/controlling device can include an electrical connection structure. The method can include connecting the connector of the wire to the connection structure of the sensing/controlling device, and preventing force from transmitting from the suspension system to the wire by contacting a portion of the wire with the strain relief portion of the connector.

In accordance with another aspect, a method can include providing a wire that includes at least one lead enclosed in a polyurethane sheath. The method can also include contacting the polyurethane sheath with the strain relief portion of the connector to prevent force from transmitting between various structures, including between the wire and the connector.

In accordance with yet another aspect, a method can include providing the sensing/controlling device as an antilock brake sensor attached to the wheel mount structure.

In accordance with another aspect, a method can include providing the sensing/controlling device as an active suspension sensor or an active stabilizer bar sensor.

In accordance with another aspect, a method can include providing a wire that includes at least one lead enclosed in a polyurethane sheath along a first portion and extending from and exposed from the polyurethane sheath along a connection end portion thereof, and preventing force from transmitting includes forming the strain relief portion such that it bridges over the exposed portion of the lead and then contacts the polyurethane sheath.

In accordance with yet another aspect, a method can include forming the strain relief portion with at least one arm that extends over the exposed portion of the lead and then contacts the polyurethane sheath, or forming the strain relief portion with a plurality of arms that extend over the exposed portion of the lead and then contact the polyurethane sheath, or forming the strain relief portion in a tubular shape that extends over the exposed portion of the lead and then contacts the polyurethane sheath.

In accordance with another aspect, a vehicle wheel mount connection structure can include a vehicle body portion, a wheel mount structure located adjacent and moveable with respect to the vehicle body portion, a sensing/controlling device located adjacent the wheel mount structure and including a connection structure, a high flex wire extending from the vehicle body portion to the wheel mount structure, and a connector located on the wire and having a strain relief portion. The connector can be configured for connection to the connection structure of the sensing/controlling device.

In accordance with yet another aspect, a vehicle wheel mount connection can include a wire that has at least one lead covered with a polyurethane sheath, and the strain relief portion extends from a rear of the connector, over the at least one lead of the wire, and connects to the sheath of the wire. The strain relief portion can include a tubular structure or arm(s) structure that extends from a rear of the connector, over the at least one lead of the wire, and connects to the sheath of the wire.

In accordance with another aspect, the vehicle wheel mount connection structure can include a sensing/controlling device that is one of an active suspension sensor device, an active stabilizer bar sensor device, an antilock brake sensor device, a force producing device, and a friction controlling device.

In accordance with yet another aspect, a vehicle suspension connection structure can include a polyurethane high flex wire, a sensing/controlling device connection structure, and a connector located adjacent a connection end of the high flex wire and having a strain relief portion. The connector can be configured to be connected to the sensing/controlling device connection structure. The strain relief portion can contact the polyurethane high flex wire such that forces are substantially prevented from transmitting from the sensing/controlling device connection structure to the wire.

In accordance with yet another aspect, a vehicle suspension connection structure can include a wire that has at least one lead covered with a polyurethane sheath, and the strain relief portion can extend from a rear of the connector, over the at least one lead of the wire, and connect to the sheath of the wire. The strain relief portion can include a tubular structure or arm(s) structure that extends from a rear of the connector, over the at least one lead of the wire, and connects to the sheath of the wire.

In accordance with another aspect, the vehicle suspension connection structure can include a sensing/controlling device that is one of an active suspension sensor device, an active stabilizer bar sensor device, an antilock brake sensor device, a force producing device, and a friction controlling device.

Still other features and characteristics of the disclosed subject matter will become apparent to those skilled in the art from a reading of the following detailed description of embodiments constructed in accordance therewith, and taken in conjunction with the accompanying drawings.

### BRIEF DESCRIPTION OF THE DRAWINGS

The disclosed subject matter will now be described in more detail with reference to exemplary embodiments of the wire connector and method of using the wire connector, given only by way of example, and with reference to the accompanying drawings, in which:

FIG. 1 is a perspective view of an embodiment of a connector in the process of connecting a wire to a component of a vehicle in accordance with principles of the disclosed subject matter;

FIGS. 2A-F are a perspective view (FIG. 2A), a top view (FIG. 2B), a cross-section view along line IIC-IIC of FIG. 2B (FIG. 2C), a side view (FIG. 2D), a cross-section view along line IIE-IIE of FIG. 2D (FIG. 2E), and another side view (FIG. 2F) of a connector made in accordance with principles of the disclosed subject matter; and

FIG. 3 is a cross sectional side view of another embodiment of a connector and wire made in accordance with principles of the disclosed subject matter; and

FIG. 4 is a cross sectional side view of another embodiment of a connector and wire made in accordance with principles of the disclosed subject matter.

### DETAILED DESCRIPTION OF EXEMPLARY EMBODIMENTS

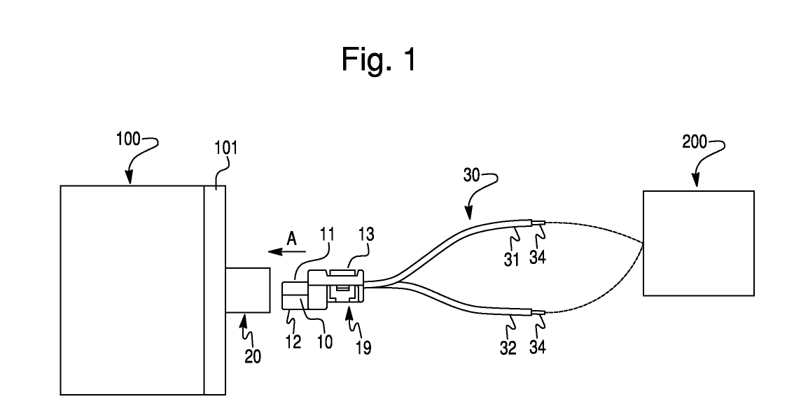

The disclosed subject matter relates to a method and apparatus for connecting wires to high vibration components in a vehicle. As shown in FIG. 1, a wire connector 10 can be provided at an end of wires 30. The wire connector 10 can be either a male or female type connector, and configured to connect with a mating connector 20. The mating connector 20 in this example is connected to a sensing/controlling device 101 that is attached to a vehicle component 100 that is to be monitored or controlled, such as an ABS component, another wheel mount component, an active stabilizer bar, an active suspension component, a vibration isolator (damper or bushing), or other component(s) of a vehicle. Arrow A shows a possible direction for connecting the wire connector 10 to the mating connector 20 to ensure stable electrical connection between the wire connector 10 and mating connector 20. Other devices that are contemplated for use as a sensing/controlling device 101 include force production devices, friction controlling or producing devices, and other active components of a vehicle.

In one exemplary embodiment, wires 30 can be configured to electrically connect the vehicle sensing/controlling device 101 to a vehicle monitoring/controlling device 200 when the wire connector 10 and mating connector 20 are connected. The vehicle monitoring/controlling device 200 can be any of various types of monitoring devices, such as a CPU, a programmable logic controller, a simple switch mechanism, or other component(s) that act upon information provided by a sensor located on a vehicle component. The wires 30 can include polyurethane outer sheathes 31 and 32 that cover and protect leads 34 from the environment and from shorting against each other or other conductive materials. The leads 34 can be made of any suitable conductive material, such as braided copper strands, aluminum wire, steel, metal alloys, etc. The sensing/controlling device 101 can be any of various types of sensors and active controllers, including ABS sensors or controllers, active stabilizer bar sensors or controllers, active suspensions system sensors or controllers, force producing devices, friction controlling devices, etc.

The wires 30 located between the vehicle component 100 and the vehicle monitoring device 200 can be configured such that an information signal can be consistently carried by the wires 30. However, in many high vibration applications, the gauge of the wires 30 is determined more by the physical parameters (e.g., the vibration parameters and the environmental parameters) that the wires 30 must withstand than by the type or amount of signal/electrical charge that must be carried by the wires 30.

As shown in FIG. 1, a strain relief cover 19 can be clipped onto the wire connector 10 to provide a strain relief portion 13. The strain relief portion 13 can include an arm portion 16 (or arm portions) that extend from a rear of the body portion 12 of the strain relief cover 19 for contacting the sheath portion 31 or 32 of a wire 30. The arm portion 16 can be configured to stabilize and support the wire, and prevent a concentration of vibration force on a specific portion of the wire 30.

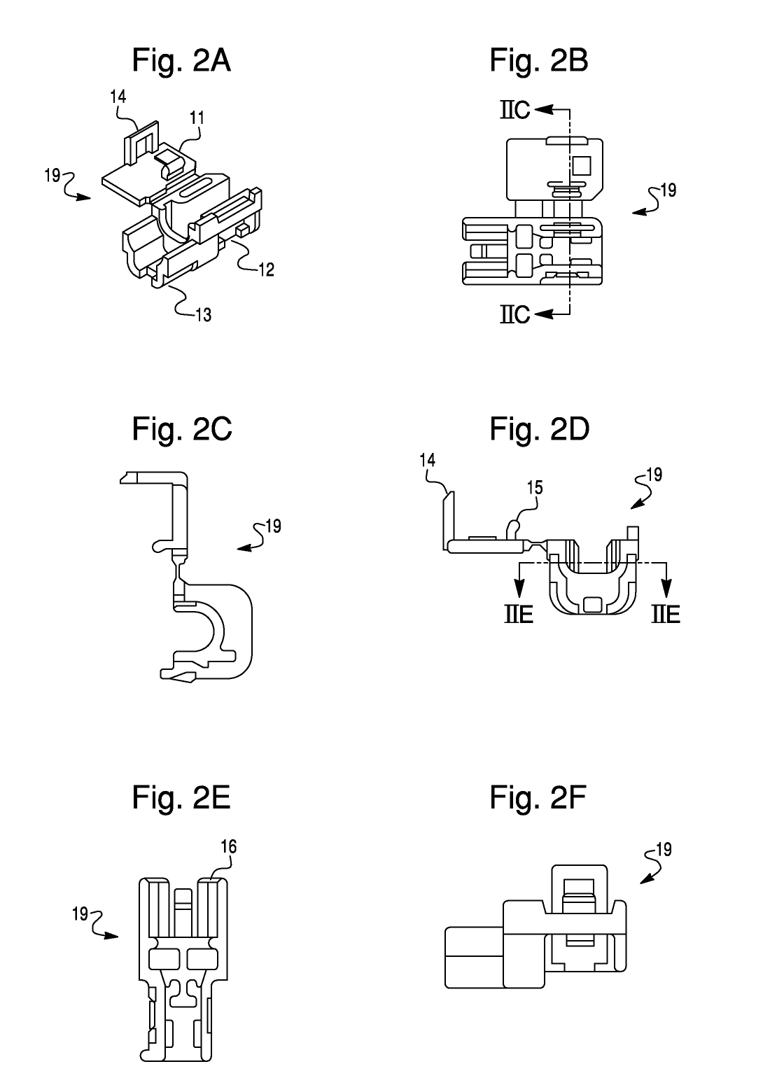

As shown in FIGS. 2A-F, the strain relief cover 19 can be separate from the wire connector 10 and include a body portion 12, a lock portion 11, and a strain relief portion 13. The body portion 12 can be configured to enclose or partially enclose a wire connector 10 and wire 30 when the lock portion 11 is closed or clipped onto the body portion 12. In particular, the lock portion 11 can be shaped as a hinged door that includes one or more locking mechanisms for locking to the body portion 12. The strain relief cover 19 shown in FIGS. 2A-F includes a door shaped lock portion 11 that can be rotated about a hinge and locked with the body portion 12 via a distal lock tab 14 and a proximal lock tab 15 formed in the door portion of the lock portion 11.

It is also contemplated that the strain relief cover 19 can be formed as a one piece structure that simultaneously serves as both strain relief cover and connector. In such an embodiment, the strain relief structure would be integral with the connector body.

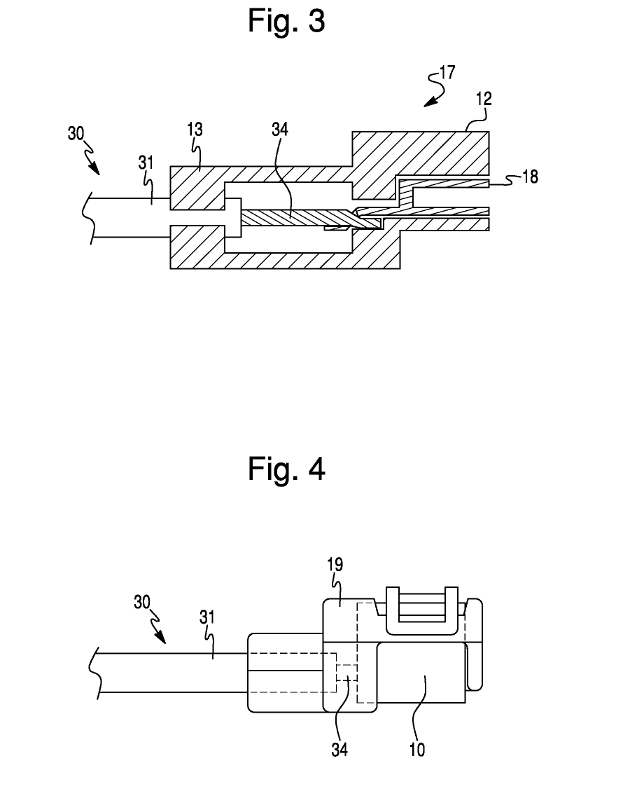

As shown in FIG. 3, the strain relief portion 13 of an integral connector/strain relief cover 17 can be configured as a tubular structure located at a rear end of the body portion 12 such that the strain relief portion 13 contacts the outer sheath portion 31 of wire 30 when the wire 30 is locked within the body portion 12 of the connector/strain relief cover 17. Thus, the strain relief portion 13 provides support for a bare/exposed portion of lead 34 located between the outer sheath portion 32 and the connector body portion 12. The support provided by the strain relief portion 13 of the connector/strain relief cover 17 prevents the vibration of the vehicle component 100 from concentrating at the bare portion of wire lead 34, and thus prevents failure of the wire 30 at the location immediately adjacent the connector/strain relief cover 17. The connector/strain relief cover 17 with strain relief portion 13 provides a durable and possibly reusable connection device for the high vibration environment of a vehicle.

In FIG. 4, the wire connector 10 is separate from the connector that is formed as a strain relief cover 19. In this embodiment, the strain relief cover 19 can be configured to be used on many various and commonly used connectors 10, such that a pre-existing system that includes a wire 30 and wire connector 10 can be retrofitted with a strain relief cover 19. Thus, the benefits of the disclosed subject matter can be realized with already existing wiring systems on vehicles, and with already existing wiring inventory.

In the above described embodiments, a connection device 18 can be provided via a weld or other connective structure at the end of wire 30 for connection to a mating connection device in the mating connector 20. However, it should be understood that the specific configuration and connection shown for the connection device 18 and connector can vary in shape and configuration. Moreover, the connectors (connector/strain relief cover 17, wire connector 10, and strain relief cover 19) and connection device 18 shown in the figures are only some examples of the different contemplated possible configurations for the connectors and connection device 18 according to the disclosed subject matter.

For example, any of the disclosed connectors, such as the wire connector 10, connector/strain relief cover 17 or wire strain relief cover 19 can also be formed as a single unit that is connected to the wire 30 during production of the wire such that no door portion is required. In addition, the wire connector 10, connector/strain relief cover 17, or wire strain relief cover 19 can be formed with a conductive material insert that mates with the mating connector 20 during connection of the wire 30 to the vehicle component 100 (i.e., a conductive connection device can be pre-formed in the wire connector 10, connector/strain relief cover 17, or wire strain relief cover 19, eliminating the need for the connection device 18 to be pre-formed via a connection to wire 30). Alternatively, the wire 30 can include a pre-formed conductive connector device that is then sandwiched within the wire connector 10, connector/strain relief cover 17, or wire strain relief cover 19 at a later time. In this case, the geometry of the wire connector 10 can be configured such that it can hold the wire and the pre-fabricated conductive connector device on the wire 30. Likewise, the mating connector 20 can include a prefabricated conductive material connector built in the connector 20 or it can be configured to connect with a wire that has a prefabricated conductive connector thereon. In either case, the connector 20 and the wire connector 10 should be formed such that they mate with each other to form a consistent electrical connection.

The strain relief portion 13 of FIGS. 2A-F is shown including arm portions 16 that extend from a rear of the body portion 12 such that the relief portion 13 contacts the polyurethane sheath 31 on the wire 30. However, it is contemplated that the strain relief portion 13 can be formed as part of the door lock portion 11, or as an integral extension of the body portion 12. In addition, the strain relief portion 13 can be configured as a separate extension or plurality of extensions that extend a substantial distance away from the body portion 12 of the connector. The strain relief portion 13 can also be formed as a tubular member that extends from the body portion 12, as shown in FIG. 3. Basically, the strain relief portion 13 can include configurations that spread out the concentration of vibration force from that portion of wire 30 that is bare (does not include a sheath covering 31 or 32) and/or disperses the vibration energy from the wire at the position located adjacent the body portion 12.

While the disclosed subject matter has been described in detail with reference to exemplary embodiments thereof, it will be apparent to one skilled in the art that various changes can be made, and equivalents employed, without departing from the scope of the invention. Each of the conventional art documents referenced above is hereby incorporated by reference in its entirety.

What is claimed is:

1. A method of connecting a wire to a high vibration vehicle component, comprising:
providing a vehicle suspension system including a wheel mount structure, a sensing/controlling device attached to the suspension system, and a high flex wire including a connector having a strain relief portion, the sensing/controlling device including a mating electrical connection structure;
connecting the connector of the wire to the mating electrical connection structure of the sensing/controlling device; and
preventing force from transmitting from the suspension system to the wire by contacting a portion of the wire with the strain relief portion of the connector.

2. The method of claim 1, wherein the wire includes at least one lead enclosed in a polyurethane sheath, and
preventing force from transmitting includes contacting the polyurethane sheath with the strain relief portion of the connector.

3. The method of claim 1, wherein the sensing/controlling device is an antilock brake sensor attached to the wheel mount structure.

4. The method of claim 1, wherein the sensing/controlling device is one of an active suspension sensor, an active stabilizer bar sensor, a force producing device, and a friction controlling device.

5. The method of claim 1, wherein the wire includes at least one lead enclosed in a polyurethane sheath along a first portion of the lead, the lead extending from and exposed from the polyurethane sheath along an exposed connection end portion of the lead, and
preventing force from transmitting includes forming the strain relief portion such that it bridges over the exposed portion of the lead and then contacts the polyurethane sheath.

6. The method of claim 5, wherein forming the strain relief portion includes forming the strain relief portion with at least one arm that extends over the exposed portion of the lead and then contacts the polyurethane sheath.

7. The method of claim 5, wherein forming the strain relief portion includes forming the strain relief portion in a tubular shape that extends over the exposed portion of the lead and then contacts the polyurethane sheath.

8. The method of claim 5, further comprising:
connecting an opposite end of the wire to a monitoring/controlling device; and
at least one of monitoring and controlling the vehicle component via the monitoring/controlling device.

9. The method of claim 1, wherein the connector is one of a one piece combined connector/strain relief structure and a separate wire strain relief cover configured for attachment over a wire connector.

10. A vehicle wheel mount connection structure, comprising:
a vehicle body portion;
a wheel mount structure located adjacent and moveable with respect to the vehicle body portion;
a sensing/controlling device located adjacent the wheel mount structure and including a connection structure;
a high flex wire extending from the vehicle body portion to the wheel mount structure;
a connector located adjacent the wire and having a strain relief portion, the connector being configured for connection to the connection structure of the sensing/controlling device.

11. The vehicle wheel mount connection structure of claim 10, wherein the wire includes at least one lead covered with a polyurethane sheath, and
the strain relief portion extends from a rear of the connector, over the at least one lead of the wire, and connects to the sheath of the wire.

12. The vehicle wheel mount connection structure of claim 11, wherein the strain relief portion includes a tubular structure that extends from a rear of the connector, over the at least one lead of the wire, and connects to the sheath of the wire.

13. The vehicle wheel mount connection structure of claim 10, wherein the sensing/controlling device is one of an active suspension sensor device, an active stabilizer bar sensor device, an antilock brake sensor device, a force producing device and a friction controlling device.

14. The vehicle wheel mount connection structure of claim 10, wherein the connector is one of a one piece combined connector/strain relief structure and a separate wire strain relief cover configured for attachment over a wire connector.

15. A vehicle suspension connection structure, comprising:
a polyurethane high flex wire having a connection end;
a sensing/controlling device connection structure;
a connector located adjacent the connection end of the high flex wire and having a strain relief portion, the connector configured to be connected to the sensing/controlling device connection structure, and the strain relief portion contacting the polyurethane high flex wire such that forces are substantially prevented from transmitting from the sensing/controlling device connection structure to the polyurethane high flex wire.

16. The vehicle suspension connection structure of claim 15, wherein the polyurethane high flex wire includes at least one lead covered with a polyurethane sheath, and
the strain relief portion extends from a rear of the connector, over the at least one lead of the polyurethane high flex wire, and connects to the sheath of the polyurethane high flex wire.

17. The vehicle suspension connection structure of claim 15, wherein the polyurethane high flex wire includes at least one lead covered with a polyurethane sheath, and
the strain relief portion extends in a tubular form from a rear of the connector, over the at least one lead of the polyurethane high flex wire, and connects to the sheath of the polyurethane high flex wire.

18. The vehicle suspension connection structure of claim 15, wherein the strain relief portion includes an arm that extends from a rear of the connector, over the at least one lead of the polyurethane high flex wire, and connects to the sheath of the polyurethane high flex wire.

19. The vehicle suspension connection structure of claim 15, further comprising:
a sensing/controlling device connected to the sensing/controlling device connection structure, the sensing/controlling device is at least one of an active suspension sensor device, an active stabilizer bar sensor device, an antilock brake sensor device, a force producing device, and a friction controlling device.

20. The vehicle suspension connection structure of claim 15, wherein the connector is one of a one piece combined connector/strain relief structure and a separate wire strain relief cover configured for attachment over a wire connector.
